(19) United States
(12) Patent Application Publication
(10) Pub. No.: US 2022/0187643 A1
(43) Pub. Date: Jun. 16, 2022

(54) LIQUID CRYSTAL DISPLAY DEVICE

(71) Applicant: Japan Display Inc., Tokyo (JP)

(72) Inventor: Yosuke HYODO, Tokyo (JP)

(73) Assignee: Japan Display Inc., Tokyo (JP)

(21) Appl. No.: 17/546,543

(22) Filed: Dec. 9, 2021

(30) Foreign Application Priority Data
Dec. 11, 2020 (JP) 2020-205972

(51) Int. Cl. G02F 1/1347; G02F 1/1335

(52) U.S. Cl. CPC G02F 1/1347; G02F 2202/28; G02F 1/133528

(57) ABSTRACT

According to one embodiment, a liquid crystal display device includes a first display panel, a backlight and a second display panel. The first display panel includes a display area for displaying an image. The second display panel is provided between the first display panel and the backlight and controls brightness of the image displayed on the first display panel. The first display panel and the second display panel both include a liquid crystal layer. A first refractive index of a member provided between the liquid crystal layer of the second display panel and the liquid crystal layer of the first display panel is higher than a second refractive index of a member provided above the liquid crystal layer of the first display panel.

### CROSS-REFERENCE TO RELATED APPLICATIONS

This application is based upon and claims the benefit of priority from Japanese Patent Application No. 2020-205972, filed Dec. 11, 2020, the entire contents of which are incorporated herein by reference.

### FIELD

Embodiments described herein relate generally to a liquid crystal display device.

### BACKGROUND

In recent years, in order to improve the contrast of the display device, a technology using a display panel for dimming in addition to a display panel for image display has been developed. However, in this technology, since the two display panels are configured to overlap each other, when an observer observes the display image, parallax according to the distance between the display layer of one display panel and the display layer of the other display panel is generated, and there is a possibility that the display quality is deteriorated such as occurrence of a double image.

### BRIEF DESCRIPTION OF THE DRAWINGS

FIG. 1 is an exploded perspective view showing a configuration example of a display device including two display panels.

FIG. 2 is a cross-sectional view schematically showing a configuration of the display device illustrated in FIG. 1.

FIG. 3 is a schematic diagram for describing a double image that can occur in a display device including two display panels.

FIG. 4 is another schematic diagram for describing a double image that can occur in a display device including two display panels.

FIG. 5 is a diagram for describing halo that can occur in a display device including two display panels.

FIG. 6 is a schematic diagram showing a configuration according to an embodiment and a configuration according to a comparative example in comparison.

FIG. 7 is a diagram for describing a relationship between a refractive index and parallax in the display device having the configuration according to the embodiment.

FIG. 8 is another diagram for describing the relationship between the refractive index and the parallax in the display device having the configuration according to the embodiment.

### DETAILED DESCRIPTION

In general, according to one embodiment, a liquid crystal display device includes a first display panel, a backlight and a second display panel. The first display panel includes a display area for displaying an image. The backlight is provided on an opposite side of a display surface of the first display panel. The second display panel is provided between the first display panel and the backlight and controls brightness of the image displayed on the first display panel. The first display panel and the second display panel both include a liquid crystal layer. A first refractive index of a member provided between the liquid crystal layer of the second display panel and the liquid crystal layer of the first display panel is higher than a second refractive index of a member provided above the liquid crystal layer of the first display panel.

Embodiments will be described hereinafter with reference to the accompanying drawings.

The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

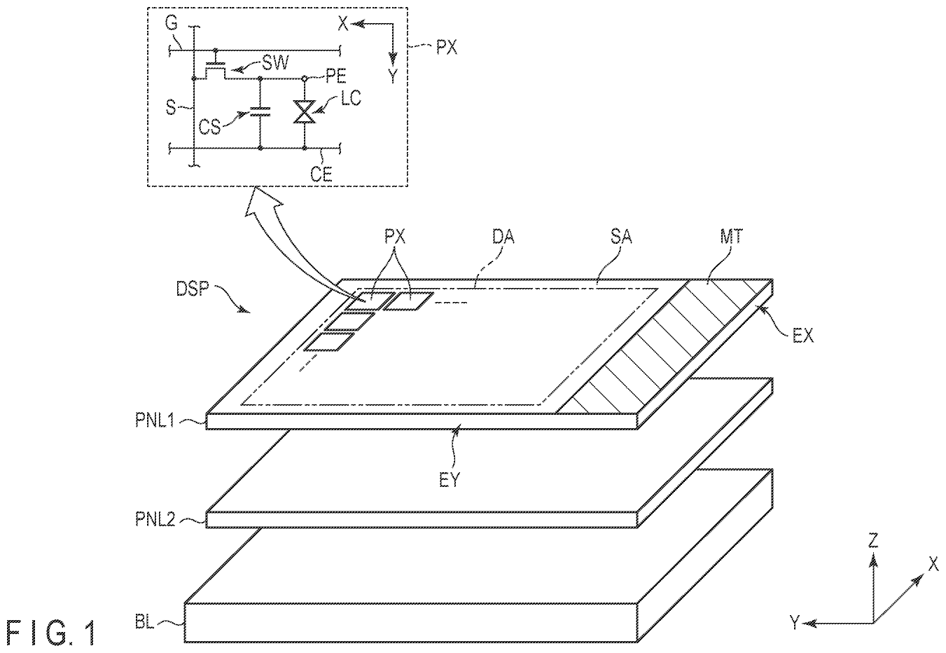

FIG. 1 is an exploded perspective view schematically showing a configuration of a display device DSP1 comprising two display panels. The display device DSP1 may be referred to as a liquid crystal display device. FIG. 1 illustrates a three-dimensional space defined by a first direction X, a second direction Y orthogonal to the first direction X and a third direction Z orthogonal to the first direction X and the second direction Y. Note that the first direction X and the second direction Y are orthogonal to each other, but they may intersect at an angle other than 90 degrees. In the following descriptions, the third direction Z is referred to as “upward” and a direction opposite to the third direction Z is referred to as “downward”. With such expressions “a second member above a first member” and “a second member below a first member”, the second member may be in contact with the first member or may be remote from the first member. In addition, it is assumed that there is an observation position to observe the semiconductor substrate along the third direction Z, and viewing from this observation position toward the X-Y plane defined by the first direction X and the second direction Y is referred to as a planar view.

As shown in FIG. 1, the display device DSP includes a liquid crystal display panel PNL1 (a first display device), a dimming panel PNL2 (a second display device), and a backlight unit BL. As shown in FIG. 1, the dimming panel PNL2 is disposed between the liquid crystal display panel PNL1 and the backlight unit BL, so that the contrast of the image displayed on the liquid crystal display panel PNL1 can be improved.

The liquid crystal display panel PNL1 has, for example, a rectangular shape. In the illustrated example, a shorter side EX of the liquid crystal display panel PNL1 is parallel to the first direction X, and a longer side EY of the liquid crystal display panel PNL1 is parallel to the second direction Y. The third direction Z corresponds to the thickness direction of the liquid crystal display panel PNL1. The main surface of the liquid crystal display panel PNL1 is parallel to the X-Y plane defined by the first direction X and the second direction Y. The liquid crystal display panel PNL1 includes a display area DA and a peripheral area SA outside the display area DA. The peripheral area SA has a terminal region MT on which an IC chip or a flexible printed circuit is mounted. In FIG. 1, the terminal region MT is indicated by hatched line.

The display area DA is an area for displaying an image, and includes, for example, a plurality of pixels PX arrayed in a matrix. As illustrated in an enlarged manner in FIG. 1, each pixel PX is arranged in a region partitioned by a scanning line G and a signal line S, and includes a switching element SW, a pixel electrode PE, a common electrode CE, a liquid crystal layer LC, and the like.

The switching element SW includes, for example, a thin-film transistor (TFT), and is electrically connected to the scanning line G and the signal line S. The scanning line G is electrically connected to the switching element SW in each of the pixels PX arranged in the first direction X. The signal line S is electrically connected to the switching element SW in each of the pixels PX arranged in the second direction Y. The pixel electrode PE is electrically connected to the switching element SW. Each of the pixel electrodes PE faces the common electrode CE, and the liquid crystal layer LC is driven by an electric field generated between the pixel electrode PE and the common electrode CE. The capacitance CS is formed, for example, between an electrode having the same electric potential as the common electrode CE and an electrode having the same electric potential as the pixel electrode PE.

The terminal region MT is provided along the shorter side EX of the liquid crystal display panel PNL1 and includes a terminal for electrically connecting the liquid crystal display panel PNL1 to an external device or the like. The liquid crystal display panel PNL1 is electrically connected to an external device such as a flexible printed circuit via a terminal portion provided in the terminal region MT.

Although a detailed configuration is not shown in FIG. 1, the dimming panel PNL2 basically has the same configuration as the liquid crystal display panel PNL1.

The backlight unit BL is disposed on the lower side of the dimming panel PNL2, and an image is displayed by controlling light from the backlight unit BL for each pixel PX.

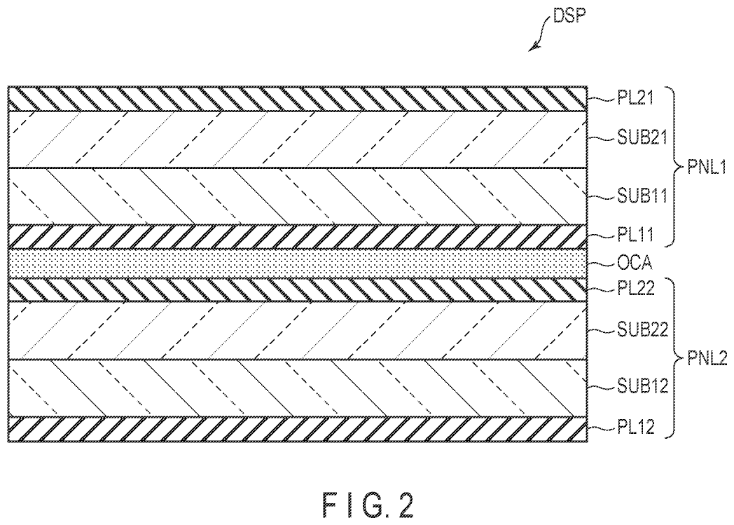

FIG. 2 is a cross-sectional view schematically showing a configuration of the display device DSP illustrated in FIG. 1.

As described above, the display device DSP includes the liquid crystal display panel PNL1, the dimming panel PNL2, and the backlight unit BL. In FIG. 2, illustration of the backlight unit BL is omitted. In FIG. 2, for convenience of explanation, illustration of a partial configuration of the liquid crystal display panel PNL1 and the dimming panel PNL2 is omitted.

As shown in FIG. 2, the liquid crystal display panel PNL1 and the dimming panel PNL2 are bonded to each other by, for example, a transparent adhesive layer OCA. More specifically, the liquid crystal display panel PNL1 and the dimming panel PNL2 are bonded to each other by the adhesive layer OCA after position adjustment is performed so that the liquid crystal display panel PNL1 and the dimming panel PNL2 are superposed in planar view as the common configuration between them.

Hereinafter, first, the configuration of the liquid crystal display panel PNL1 will be described.

As shown in FIG. 2, liquid crystal display panel PNL1 includes a first substrate SUB11, a second substrate SUB21, a first polarizer PL11, and a second polarizer PL21. Although not shown in FIG. 2 for convenience of description, a liquid crystal layer is provided between the first substrate SUB11 and the second substrate SUB21, and the liquid crystal layer is sealed by a sealant (not shown).

The first polarizer PL11 is provided below the first substrate SUB11, and the second polarizer PL21 is provided above the second substrate SUB21. The polarization axis of the first polarizer PL11 and the polarization axis of the second polarizer PL21 have, for example, a crossed Nicols relationship, that is, 90 degrees.

Next, a configuration of the dimming panel PNL2 will be described.

As shown in FIG. 2, similarly to the liquid crystal display panel PNL1, the dimming panel PNL2 includes a first substrate SUB12, a second substrate SUB22, a first polarizer PL12, and a second polarizer PL22. Similarly to the liquid crystal display panel PNL1, a liquid crystal layer is provided between the first substrate SUB12 and the second substrate SUB22, and the liquid crystal layer is sealed by a sealant (not shown).

The first polarizer PL12 is provided below the first substrate SUB12, and the second polarizer PL22 is provided above the second substrate SUB22. The polarization axis of the first polarizer PL12 and the polarization axis of the second polarizer PL22 have, for example, a crossed Nicols relationship, that is, 90 degrees. The polarization axis of the first polarizer PL11 of the liquid crystal display panel PNL1 and the polarization axis of the second polarizer PL22 of the dimming panel PNL2 are in the same direction.

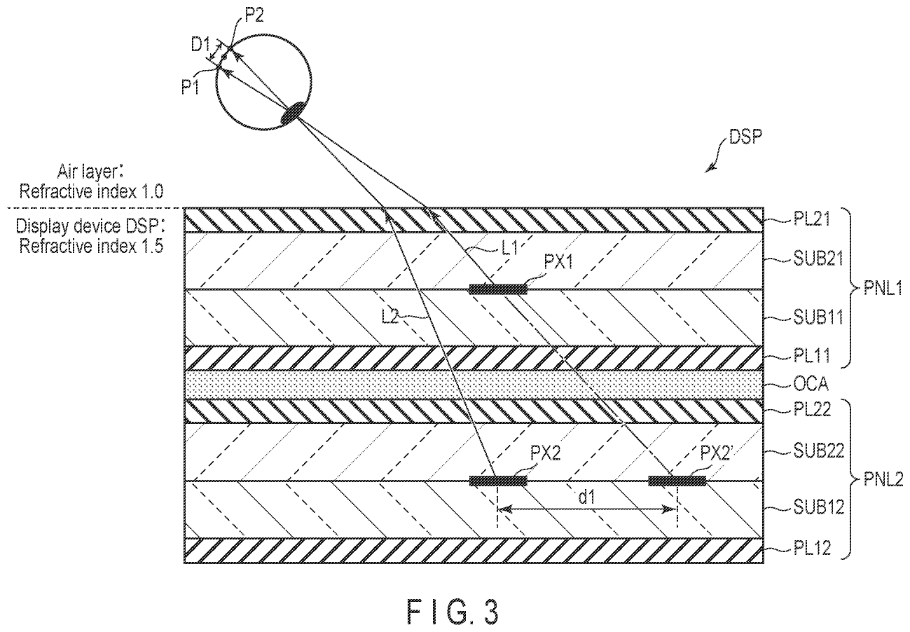

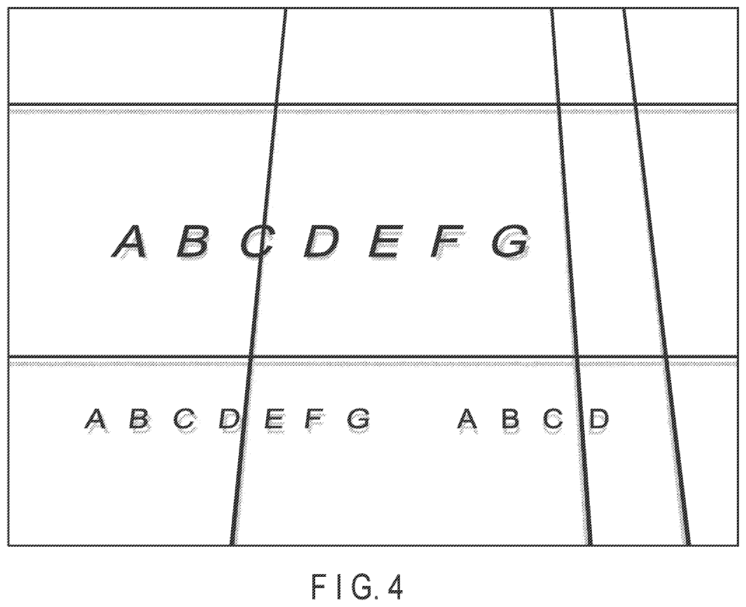

Here, problems that may occur in two display panels, specifically, a display device DSP including a liquid crystal display panel PNL1 and a dimming panel PNL2 will be described with reference to FIGS. 3 to 5. FIGS. 3 and 4 are schematic diagrams for describing a double image that can occur in the display device DSP.

FIG. 3, it is assumed that an image is displayed on a pixel PX1 of liquid crystal display panel PNL1. In this case, a pixel of the dimming panel PNL2 corresponding to the pixel PX1 of the liquid crystal display panel PNL1, specifically, a pixel PX2 of the dimming panel PNL2 located immediately below the pixel PX1 is also controlled to be turned on (or turned off) for dimming.

Therefore, when the observer observes the pixel PX1 from the oblique direction of the display surface in order to observe the image displayed on the pixel PX1 of the liquid crystal display panel PNL1, a light beam corresponding to the pixel PX2 of the dimming panel PNL2 is incident on an eye of the observer in addition to a light beam corresponding to the pixel PX1 of the liquid crystal display panel PNL1. More specifically, the light beam corresponding to the pixel PX1 of the liquid crystal display panel PNL1 is incident on the eye of the observer following an optical path L1 illustrated in FIG. 3, and an image is formed on a retina of the observer. Similarly, in the eye of the observer, the light beam corresponding to the pixel PX2 of the dimming panel PNL2 is incident on the eye of the observer following an optical path L2 illustrated in FIG. 3, and an image is formed on the retina of the observer.

According to this, as shown in FIG. 3, the light beam corresponding to the pixel PX1 of the liquid crystal display panel PNL1 and the light beam corresponding to the pixel PX2 of the dimming panel PNL2 form images at different positions on the retina of the observer. More specifically, the light beam corresponding to the pixel PX1 of the liquid crystal display panel PNL1 forms an image at P1 in FIG. 3, and the light beam corresponding to the pixel PX2 of the dimming panel PNL2 forms an image at P2 in FIG. 3. That is, a difference corresponding to D1 in FIG. 3 is generated between the position (hereinafter, referred to as an imaging position) P1 on the retina where the light beam corresponding to the pixel PX1 of the liquid crystal display panel PNL1 forms an image and an imaging position P2 where the light beam corresponding to the pixel PX2 of the dimming panel PNL2 forms an image. This difference is referred to as parallax, and according to the parallax, for example, as shown in FIG. 4, a problem that the display image is seen doubly (that is, a problem that a double image occurs) occurs.

In principle, the parallax can be made zero by the light beam corresponding to the pixel PX1 of the liquid crystal display panel PNL1 and the light beam corresponding to the pixel PX2 of the dimming panel PNL2 forming an image at the same position on the retina of the observer. That is, assuming that the pixel PX2 of the dimming panel PNL2 is at the position of a pixel PX2′ from which a light beam following the same optical path as the light beam corresponding to the pixel PX1 of the liquid crystal display panel PNL1 can be emitted, the parallax can be made zero, and in view of this, the number of pixels (that is, a difference corresponding to d1 in FIG. 3) between the pixel PX2 and the pixel PX2′ may be referred to as the parallax.

As a method for suppressing occurrence of a double image due to the parallax described above, blurring process is known. The blurring process is a method in which, for example, when an image is displayed on the pixel PX1 of the liquid crystal display panel PNL1, in addition to the pixel PX2 of the dimming panel PNL2 corresponding to the pixel PX1, pixels located around the pixel PX2 are controlled to be turned on (or turned off) for dimming, and the image displayed on the liquid crystal display panel PNL1 is blurred and displayed.

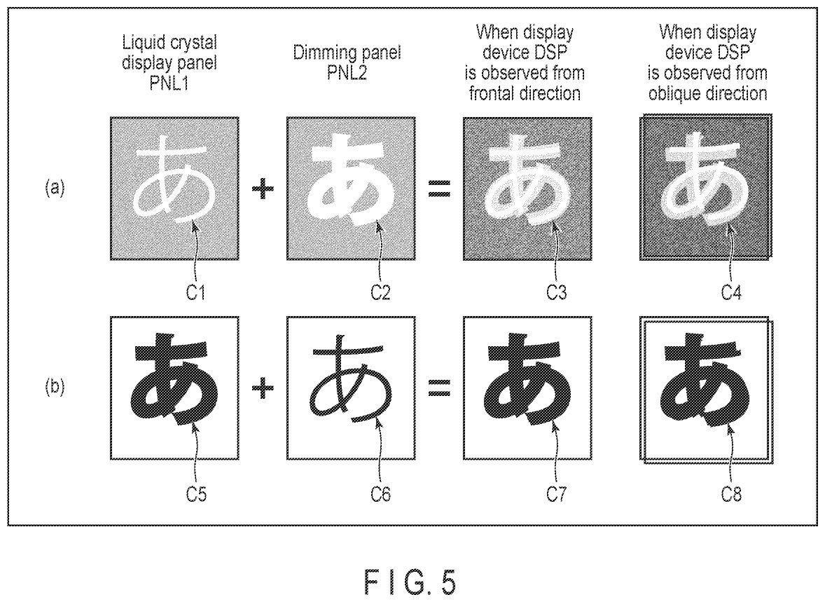

FIG. 5 is a diagram for describing the above-described blurring process. An (a) of FIG. 5 is a schematic diagram for describing blurring process in a case where a pixel corresponding to a display image is controlled to turned on so that the display image is displayed in white. On the other hand, (b) of FIG. 5 is a schematic diagram for describing blurring process in a case where a pixel corresponding to a display image is controlled to be turned off so that the display image is displayed in black.

In a case where the display image is displayed in white, in the liquid crystal display panel PNL1, as shown in (a) of FIG. 5, in order to display an image of a character C1 in white, one or more pixels PX1 corresponding to the image are controlled to be turned on, and the other pixels PX1 are controlled to be turned off. On the other hand, in the dimming panel PNL2, in addition to the pixel PX2 corresponding to the pixel PX1 turned on in the liquid crystal display panel PNL1, the pixel PX2 located in the periphery of the pixel PX2 is also controlled to be turned on (in other words, the pixels PX2 are controlled to spread the high gradation portion (white) to the low gradation portion (black) side). Therefore, in the dimming panel PNL2, as shown in (a) of FIG. 5, a character C2 thicker than the character C1 in the liquid crystal display panel PNL1 are displayed in white.

According to this, when the display device DSP is observed from the frontal direction, as shown in (a) of FIG. 5, a character C3 with a whitish outline is observed by the observer. On the other hand, even in a case where the display device DSP is observed from an oblique direction, since the above-described blurring process is applied to the dimming panel PNL2, the display image does not become thin, and as shown in (a) of FIG. 5, a character C4 with a whitish outline is observed by the observer. That is, according to the blurring process described above, it is possible to suppress the character from being doubly viewed and to provide the observer with the thick character with a whitish outline.

In addition, in a case where the display image is displayed in black, in the liquid crystal display panel PNL1, as shown in (b) of FIG. 5, in order to display an image of a character C5 in black, one or more pixels PX1 corresponding to the image are controlled to be turned off, and the other pixels PX1 are controlled to be turned on. On the other hand, in the dimming panel PNL2, in addition to the pixel PX2 corresponding to the pixel PX1 turned off in the liquid crystal display panel PNL1, the pixel PX2 located in the periphery of the pixel PX2 is also controlled to be turned off (in other words, also in this case, the pixels PX2 are controlled to spread the high gradation portion (white) to the low gradation portion (black) side). Therefore, in the dimming panel PNL2, as shown in (b) of FIG. 5, a character C6 which is thinner than the character C5 of the liquid crystal display panel PNL1 are displayed in black.

According to this, when the display device DSP is observed from the frontal direction, as shown in (b) of FIG. 5, the observer observes a character C7 having the same thickness as the black image displayed on the liquid crystal display panel PNL1. On the other hand, in a case where the display device DSP is observed from an oblique direction, since the above-described blurring process is applied to the dimming panel PNL2, as shown in (b) of FIG. 5, the observer observes a character C8 thicker than in a case where the display device DSP is observed from the frontal direction. That is, according to the blurring process described above, it is possible to suppress the character from being doubly viewed and to provide the thick character to the observer.

As described above, by performing the blurring process in the dimming panel PNL2, it is possible to provide a display image that is less likely to appear as a double image, more specifically, a display image having a larger outline than the display image displayed on the liquid crystal display panel PNL1, to an observer observing the display device DSP from an oblique direction.

In the blurring process described above, the wider the range (hereinafter, referred to as a blurring process range) of the pixel PX2 that is turned on or off so as to spread the high gradation portion to the low gradation portion side, the more it is possible to provide a display image that is less likely to appear as a double image to the observer. On the other hand, when the blurring process range is wide, halo occurs over a wide range, and thus there is a problem that the display quality is deteriorated. That is, according to the blurring process described above, although the occurrence of the double image due to the parallax can be suppressed, if the range of the blurring process is too wide, halo occurs over a wide range, and thus, there is a possibility that the display quality is deteriorated, for example, the display image becomes indistinct.

Therefore, the inventor of the present application has devised a configuration of a display device DSP capable of suppressing the occurrence of the double image due to the parallax by reducing the parallax itself instead of performing the blurring process to suppress the occurrence of the double image due to the parallax. In other words, the configuration of the display device DSP capable of reducing the parallax between the imaging position of the light beam corresponding to the pixel PX1 of the liquid crystal display panel PNL1 and the imaging position of the light beam corresponding to the pixel PX2 of the dimming panel PNL2 has been devised.

Specifically, a configuration has been devised in which each part from the second substrate SUB22 of the dimming panel PNL2 to the first substrate SUB11 of the liquid crystal display panel PNL1 is made of a high refractive member so that the imaging position of the light beam corresponding to the pixel PX2 of the dimming panel PNL2 approaches the imaging position of the light beam corresponding to the pixel PX1 of the liquid crystal display panel PNL1, and the parallax can be reduced. More specifically, a configuration has been devised in which each part from the second substrate SUB22 of the dimming panel PNL2 to the first substrate SUB11 of the liquid crystal display panel PNL1 is made of a high refractive member so that a refractive index (first refractive index) based on each part from the second substrate SUB22 of the dimming panel PNL2 to the first substrate SUB11 of the liquid crystal display panel PNL1 is higher than a refractive index (second refractive index) based on the second substrate SUB21 and the second polarizer PL21 of the liquid crystal display panel PNL1, and the parallax can be reduced.

Hereinafter, effects of the display device DSP according to the present embodiment will be described using a comparative example. Note that the comparative example is for describing a part of the effects that the display device DSP according to the present embodiment can exhibit, and does not exclude the effects common between the comparative example and the present embodiment from the scope of the present invention.

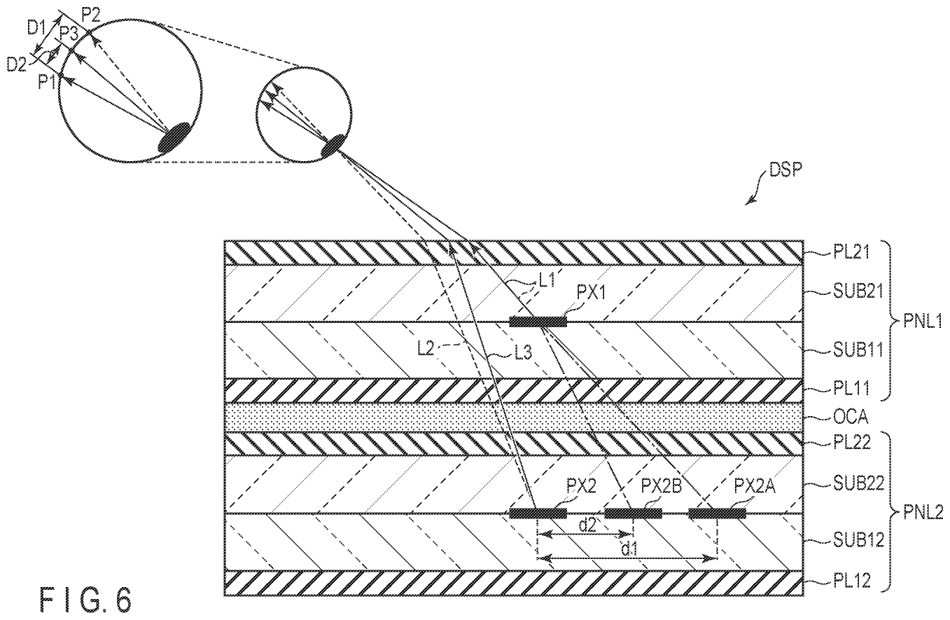

FIG. 6 is a schematic diagram showing comparison between the optical path L1 of the light beam corresponding to the pixel PX1 of the liquid crystal display panel PNL1 and the optical path L2 of the light beam corresponding to the pixel PX2 of the dimming panel PNL2 in the display device DSP having the configuration according to the comparative example, and the optical path L1 of the light beam corresponding to the pixel PX1 of the liquid crystal display panel PNL1 and the optical path L3 of the light beam corresponding to the pixel PX2 of the dimming panel PNL2 in the display device DSP having the configuration according to the present embodiment. In FIG. 6, the optical path in the display device DSP having the configuration according to the comparative example is indicated by a broken line, and the optical path in the display device DSP having the configuration according to the present embodiment is indicated by a solid line.

Note that, in the display device DSP having the configuration according to the present embodiment, as described above, each part from the second substrate SUB22 of the dimming panel PNL2 to the first substrate SUB11 of the liquid crystal display panel PNL1 is constituted by a high refractive member, and here, as an example, a refractive index based on members from the second substrate SUB22 of the dimming panel PNL2 to the first substrate SUB11 of the liquid crystal display panel PNL1 indicates a first value n1. Note that the refractive index based on the members from the second substrate SUB22 of the dimming panel PNL2 to the first substrate SUB11 of the liquid crystal display panel PNL1 corresponds to the refractive index based on the members from the display layer (liquid crystal layer) of the dimming panel PNL2 to the display layer (liquid crystal layer) of the liquid crystal display panel PNL1, and thus may be referred to as an interlayer refractive index.

On the other hand, in the display device DSP having the configuration according to the comparative example, it is assumed that each part from the second substrate SUB22 of the dimming panel PNL2 to the first substrate SUB11 of the liquid crystal display panel PNL1 is formed of a low refractive member, and for example, an interlayer refractive index from the second substrate SUB22 of the dimming panel PNL2 to the first substrate SUB11 of the liquid crystal display panel PNL1 indicates a second value n2 (<n1).

In the configuration according to the comparative example, as indicated by a broken line in FIG. 6, the light beam corresponding to the pixel PX1 of the liquid crystal display panel PNL1 is incident on the eye of the observer following the optical path L1, and forms an image at a first imaging position P1 on the retina of the observer. In addition, the light beam corresponding to the pixel PX2 of the dimming panel PNL2 is incident on the eye of the observer following the optical path L2, and forms an image at a second imaging position P2 on the retina of the observer.

Therefore, in the configuration according to the comparative example, as shown in FIG. 6, the parallax D1 is generated between the imaging position P1 of the light beam corresponding to the pixel PX1 and the imaging position P2 of the light beam corresponding to the pixel PX2. In other words, in the configuration according to the comparative example, as shown in FIG. 6, the parallax d1 corresponding to the number of pixels between the pixel PX2 and the pixel PX2A capable of emitting a light beam that virtually follows the same optical path as the light beam corresponding to the pixel PX1 is generated.

On the other hand, in the configuration according to the present embodiment, as indicated by the solid line in FIG. 6, the light beam corresponding to the pixel PX2 of the dimming panel PNL2 has the first value n1 in which the interlayer refractive index from the second substrate SUB22 of the dimming panel PNL2 to the first substrate SUB11 of the liquid crystal display panel PNL1 is larger than that in the configuration according to the comparative example. Therefore, the light beam follows the optical path L3 having a larger inclination than the optical path L2 in the comparative example, is incident on the eye of the observer, and forms an image at a third imaging position P3 on the retina of the observer.

Since the configuration according to the present embodiment and the configuration according to the comparative example are similar to each other except that the interlayer refractive index from the second substrate SUB22 of the dimming panel PNL2 to the first substrate SUB11 of the liquid crystal display panel PNL1 is different, the light beam corresponding to the pixel PX1 located above the first substrate SUB11 of the liquid crystal display panel PNL1 is not affected by the difference in the interlayer refractive index described above, and the light beam corresponding to the pixel PX1 of the liquid crystal display panel PNL1 follows the optical path L1 and is incident on the eye of the observer, and forms an image at the first imaging position P1 on the retina of the observer, similarly to the comparative example described above.

According to this, even in the configuration according to the present embodiment, as shown in FIG. 6, the parallax D2 is generated between the imaging position P1 of the light beam corresponding to the pixel PX1 and the imaging position P3 of the light beam corresponding to the pixel PX2. However, since the value of the parallax D2 can be made smaller than the parallax D1 generated in the configuration according to the comparative example, it is possible to suppress occurrence of a double image as compared with the configuration according to the comparative example. In other words, in the configuration according to the present embodiment, as shown in FIG. 6, the parallax d2 corresponding to the number of pixels between the pixel PX2 and the pixel PX2B from which a light beam following the same optical path as the light beam corresponding to the pixel PX1 can be emitted is generated, but the parallax can be reduced by the number of pixels corresponding to (d1−d2) as compared with the configuration according to the comparative example, and the occurrence of double images can be suppressed as compared with the configuration according to the comparative example.

Furthermore, according to the configuration according to the present embodiment, as described above, the occurrence of the double image can be suppressed to some extent even if the blurring process is not performed in the dimming panel PNL2. Therefore, for example, in a case where the blurring process is further performed in the dimming panel PNL2 in order to further suppress the occurrence of the double image, it is possible to sufficiently suppress the occurrence of the double image even if the blurring process range is narrow. That is, according to the configuration according to the present embodiment, it is possible to suppress occurrence of halo due to the blurring process and to keep the halo in a narrow range even if the blurring process is further added while suppressing occurrence of a double image due to parallax.

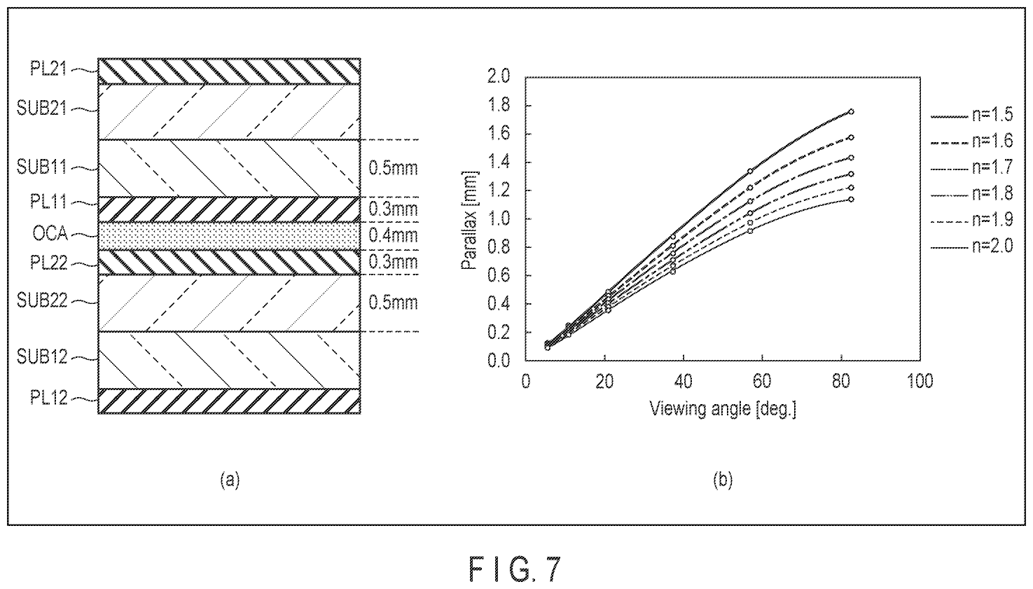

FIG. 7 is a diagram for describing a relationship between an interlayer refractive index and parallax.

Here, as shown in (a) of FIG. 7, the relationship between the interlayer refractive index and the parallax when the second substrate SUB22 of the dimming panel PNL2 has a thickness of 0.5 mm, the second polarizer PL22 has a thickness of 0.3 mm, the adhesive layer OCA has a thickness of 0.4 mm, the first polarizer PL11 of the liquid crystal display panel PNL1 has a thickness of 0.3 mm, and the first substrate SUB11 has a thickness of 0.5 mm will be described.

As shown in (b) of FIG. 7, it can be seen that the higher the interlayer refractive index, the smaller the parallax at the predetermined viewing angle. As an example, focusing on the relationship between the interlayer refractive index and the parallax in a case where the viewing angle is 80 degrees, in a case where the interlayer refractive index is 1.5, the parallax indicates about 1.8 mm, whereas in a case where the interlayer refractive index is 2.0, the parallax indicates about 1.15 mm, and it can be seen that the parallax decreases as the interlayer refractive index indicates a higher value. Note that, here, as an example, the relationship between the interlayer refractive index and the parallax in a case where the viewing angle is 80 degrees is focused. However, also in a case where the viewing angle indicates another value, similarly, the parallax indicates a smaller value as the interlayer refractive index indicates a higher value.

Therefore, in the display device DSP having the configuration according to the present embodiment in which the second substrate SUB22 of the dimming panel PNL2 to the first substrate SUB11 of the liquid crystal display panel PNL1 are formed of the high refractive member, the parallax can be reduced, and the occurrence of the double image caused by the parallax can be suppressed.

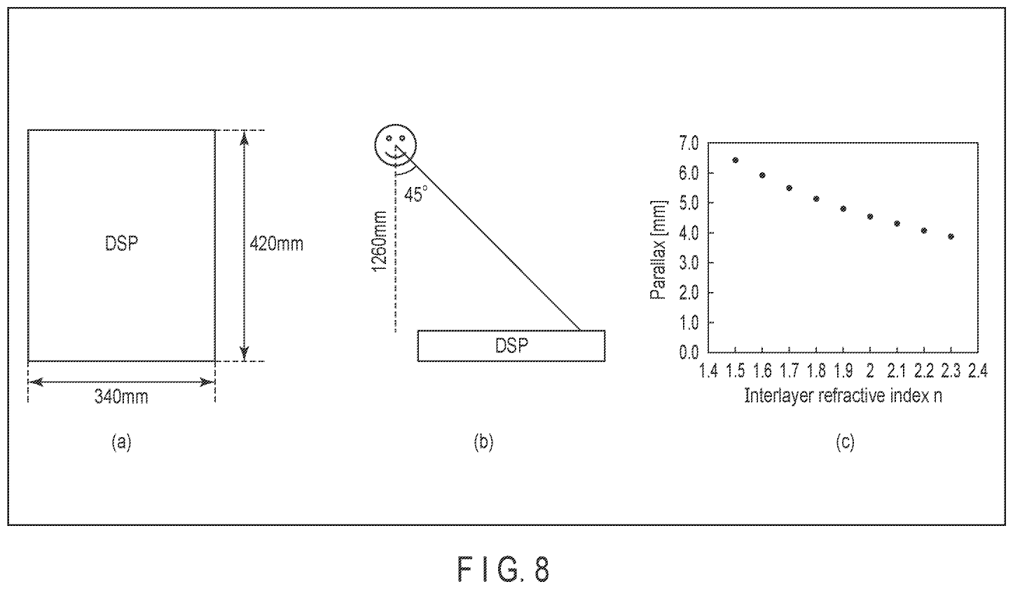

FIG. 8 is another diagrams for describing the relationship between the interlayer refractive index and the parallax.

Here, as shown in (a) and (b) of FIG. 8, the relationship between the interlayer refractive index and the parallax when the observer observes a 21-inch type display device DSP having a size of 420 mm in length×340 mm in width at a viewing angle of 45 degrees from a position separated by 1260 mm which is the optimum viewing distance will be described. The optimal viewing distance is a distance that is optimal for observing the display device DSP, and for example, three times the height of the display device DSP corresponds to the optimal viewing distance.

Also in this case, as shown in (c) of FIG. 8, it can be seen that the parallax decreases as the interlayer refractive index indicates a higher value. For example, in a case where the interlayer refractive index is 1.5, the parallax indicates about 6.5 pixels, whereas in a case where the interlayer refractive index is 2.0, the parallax indicates about 4.5 pixels, and it can be seen that the parallax is reduced by about 2 pixels.

Therefore, in the display device DSP having the configuration according to the present embodiment in which the second substrate SUB22 of the dimming panel PNL2 to the first substrate SUB11 of the liquid crystal display panel PNL1 are formed of the high refractive member, the parallax can be reduced, and the occurrence of the double image caused by the parallax can be suppressed.

As shown in (c) of FIG. 8, although the parallax can be made smaller as the interlayer refractive index indicates a higher value, it is difficult to set the interlayer refractive index to a high value such as 2.3 in consideration of the material, price, and the like of the constituent members of each part from the second substrate SUB22 of the dimming panel PNL2 to the first substrate SUB11 of the liquid crystal display panel PNL1, and the interlayer refractive index is preferably 1.6 or more and 1.9 or less.

In the display device DSP having the configuration according to the embodiment described above, each part from the second substrate SUB22 of the dimming panel PNL2 to the first substrate SUB11 of the liquid crystal display panel PNL1 is formed of a high refractive member such that the refractive index based on each part from the second substrate SUB22 of the dimming panel PNL2 to the first substrate SUB11 of the liquid crystal display panel PNL1 is higher than the refractive index based on the second substrate SUB21 and the second polarizer PL21 of the liquid crystal display panel PNL1. Consequently, the occurrence of the double image caused by the parallax can be suppressed, and the degradation of the display quality in the display device including the two display panels can be suppressed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display device comprising:
a first display panel that includes a display area for displaying an image;
a backlight that is provided on an opposite side of a display surface of the first display panel; and
a second display panel that is provided between the first display panel and the backlight and controls brightness of the image displayed on the first display panel, wherein
the first display panel and the second display panel both include a liquid crystal layer, and
a first refractive index of a member provided between the liquid crystal layer of the second display panel and the liquid crystal layer of the first display panel is higher than a second refractive index of a member provided above the liquid crystal layer of the first display panel.

2. The liquid crystal display device of claim 1, wherein
the first refractive index is a value of 1.6 or more and 1.9 or less, and
the second refractive index is a value of 1.5 or less.

3. The liquid crystal display device of claim 1, wherein
the first display panel and the second display panel both include a first substrate, a second substrate facing the first substrate, and the liquid crystal layer held between the first substrate and the second substrate,
a first polarizer is provided under the first substrate of the first display panel,
a second polarizer is provided above the second substrate of the first display panel,
a third polarizer is provided under the first substrate of the second display panel,
a fourth polarizer is provided above the second substrate of the second display panel,
the first refractive index is a refractive index based on the second substrate of the second display panel, the fourth polarizer, the first polarizer, the first substrate of the first display panel, and an adhesive layer that bonds the first display panel and the second display panel to each other, and
the second refractive index is a refractive index based on the second substrate of the first display panel and the second polarizer.

4. A liquid crystal display device comprising:
a first display panel that includes a first polarizer and a second polarizer;
a second display panel that includes a third polarizer and a fourth polarizer; and
an adhesive layer that is disposed between the first display panel and the second display panel, wherein
the first display panel is provided on the second display panel,
the first polarizer is located between the second polarizer and the adhesive layer,
the fourth polarizer is located between the adhesive layer and the third polarizer, and
a refractive index of at least one member of the first polarizer, the adhesive layer, and the fourth polarizer is higher than a refractive index of the second polarizer.

5. The liquid crystal display device of claim 4, wherein
the refractive index of the first polarizer is a value of 1.6 or more and 1.9 or less.

6. The liquid crystal display device of claim 4, wherein
the refractive index of the adhesive layer is a value of 1.6 or more and 1.9 or less.

7. The liquid crystal display device of claim 4, wherein
the refractive index of the fourth polarizer is a value of 1.6 or more and 1.9 or less.

8. The liquid crystal display device of claim 4, further comprising
a backlight, wherein
the second display panel is located between the first display panel and the backlight.
